(19) United States
(12) Patent Application Publication
(10) Pub. No.: US 2026/0281645 A1
(43) Pub. Date: Sep. 17, 2026

(54) SYSTEM AND METHOD FOR ANALYZING SOUND FIELD

(71) Applicant: MERRY ELECTRONICS (SHENZHEN) CO., LTD., GUANGDONG (CN)

(72) Inventors: Hsing-Ting CHEN, Taichung City (TW); Chun-Hung CHANG, Taichung City (TW); Hung-wei CHEN, Taichung City (TW); Po Hsun SUNG, Taichung City (TW)

(21) Appl. No.: 19/292,880

(22) Filed: Aug. 6, 2025

(30) Foreign Application Priority Data
Mar. 13, 2025 (TW) 114109396

(51) Int. Cl. H04S 7/00; G06V 10/764; G06V 20/50; H04R 5/027

(52) U.S. Cl. CPC H04S 7/30; G06V 10/764; G06V 20/50; H04R 5/027; H04S 2400/15

(57) ABSTRACT

A system for analyzing sound field in a space includes an image capturing device, an audio playing device, an audio recording device and an electronic device. The image capturing device is configured to capture at least one image of the space. The audio playing device is configured to play a test audio in the space, and the audio recording device is configured to record the test audio and output a corresponding audio signal. The electronic device is configured to: determine space information based on the image, the space information including information about one or more objects in the space; determine a plurality of audio transmission paths from the audio playing device to the audio recording device based on the space information; determine an acoustic parameter for each object based on the audio signal, the space information and the audio transmission paths.

### RELATED APPLICATIONS

This application claims priority to Taiwan Application Serial Number 114109396, filed Mar. 13, 2025, the disclosure of which is incorporated herein by reference in its entirety.

### BACKGROUND

### Technical Field

The present disclosure relates to a system and a method for analyzing sound field in a space.

### Description of Related Art

The structure of a building and the arrangement of objects inside the building have a considerable impact on the listening experience of people in the building and the sound absorption effect of the building. In order to improve the listening experience and sound absorption effect, it is necessary to perform analysis of environmental characteristics. Sound measurement devices that are currently widely used, such as sound pressure level meters, are unable to measure environmental characteristics related to spatial acoustics. On the other hand, professional equipment is expensive and is rarely used.

### SUMMARY

In view of the foregoing, one of the objects of the present disclosure is to provide a system and a method for analyzing sound field to resolve the problems described above.

In accordance with an embodiment of the present disclosure, a system for analyzing sound field in a space includes an image capturing device, an audio playing device, an audio recording device and an electronic device. The image capturing device is configured to capture at least one image of the space. The audio playing device is disposed in the space and is configured to play a test audio. The audio recording device is disposed in the space and includes at least one audio recording unit. The audio recording unit is configured to record the test audio and correspondingly output an audio signal. The electronic device is communicably coupled to the image capturing device and the audio recording device and is configured to: (1) receive the image and the audio signal; (2) determine space information based on the image, in which the space information includes information about one or more objects in the space; (3) determine a plurality of sound transmission paths from the audio playing device to the audio recording unit based on the space information; and (4) determine an acoustic parameter for each object based on the audio signal, the space information and the sound transmission paths.

In one or more embodiments of the present disclosure, the audio signal is indicative of a total energy of sound wave received by the audio recording unit. The electronic device is further configured to: (1) determine a received sound energy for each of the sound transmission paths based on the audio signal, the space information and the sound transmission paths; and (2) determine the acoustic parameter for each object based on a relation that a sum of the received sound energy associated with each of the sound transmission paths is equal to the total energy.

In one or more embodiments of the present disclosure, the sound transmission paths include a reflection path. The electronic device is configured to determine the received sound energy associated with the reflection path at least partially based on one or more first objects the reflection path passes and an angle of incidence of the reflection path at each first object. The one or more first objects are included in the one or more objects.

In one or more embodiments of the present disclosure, the sound transmission paths further include a direct path. The electronic device is further configured to extract the received sound energy associated with the direct path from the audio signal based on a length difference between the direct path and the reflection path. The received sound energy associated with the reflection path is expressed as the received sound energy associated with the direct path multiplied by an attenuation coefficient.

In one or more embodiments of the present disclosure, the electronic device is configured to determine the received sound energy associated with any one of the sound transmission paths at least partially based on a length of that sound transmission path.

In one or more embodiments of the present disclosure, the electronic device is configured to determine the received sound energy associated with any one of the sound transmission paths at least partially based on a gain of the audio recording unit and an angle of incidence of that sound transmission path at the audio recording unit. The gain is a function of the angle of incidence.

In one or more embodiments of the present disclosure, the audio recording device includes a binaural microphone.

In one or more embodiments of the present disclosure, the space information includes a category of each object, and the category is determined based on the image.

In one or more embodiments of the present disclosure, the acoustic parameter includes at least one of an acoustic absorption coefficient or an acoustic reflection coefficient.

In one or more embodiments of the present disclosure, the system further includes a rotation mechanism connected to the audio recording device. The rotation mechanism is configured to rotate the audio recording device and cause the audio recording unit to record the test audio while facing different directions.

In accordance with an embodiment of the present disclosure, a method for analyzing sound field in a space includes: (1) using an audio playing device to play a test audio in a space; (2) using at least one audio recording unit of an audio recording device to record the test audio and correspondingly output an audio signal; (3) determining space information based on at least one image of the space, the space information including information about one or more objects in the space; (4) determining a plurality of sound transmission paths from the audio playing device to the audio recording unit based on the space information; and (5) determining an acoustic parameter for each object based on the audio signal, the space information and the sound transmission paths.

In one or more embodiments of the present disclosure, the audio signal is indicative of a total energy of sound wave received by the audio recording unit. The method further includes: (1) determining a received sound energy for each of the sound transmission paths based on the audio signal, the space information and the sound transmission paths; and (2) determining the acoustic parameter for each object based on a relation that a sum of the received sound energy associated with each of the sound transmission paths is equal to the total energy.

In one or more embodiments of the present disclosure, the determining the received sound energy includes: determining the received sound energy associated with a reflection path of the sound transmission paths at least partially based on one or more first objects the reflection path passes and an angle of incidence of the reflection path at each first object. The one or more first objects are included in the one or more objects.

In one or more embodiments of the present disclosure, the determining the received sound energy includes: extracting the received sound energy associated with a direct path of the sound transmission paths from the audio signal based on a length difference between the direct path and the reflection path. The received sound energy associated with the reflection path is expressed as the received sound energy associated with the direct path multiplied by an attenuation coefficient.

In one or more embodiments of the present disclosure, the received sound energy associated with any one of the sound transmission paths is determined at least partially based on a length of that sound transmission path.

In one or more embodiments of the present disclosure, the received sound energy associated with any one of the sound transmission paths is determined at least partially based on a gain of the audio recording unit and an angle of incidence of that sound transmission path at the audio recording unit. The gain is a function of the angle of incidence.

In one or more embodiments of the present disclosure, the audio recording device includes a binaural microphone.

In one or more embodiments of the present disclosure, the determining the space information includes: determining a category of each object based on the image.

In one or more embodiments of the present disclosure, the acoustic parameter includes at least one of an acoustic absorption coefficient or an acoustic reflection coefficient.

In one or more embodiments of the present disclosure, the method further includes: rotating the audio recording device and causing the audio recording unit to record the test audio while facing different directions.

In sum, the present disclosure provides a simple and portable sound field analysis system, which can help the user quickly perform space analysis to identify the characteristics of an environment or a space. The system includes an image capturing device, an audio playing device, an audio recording device and an electronic device. The image capturing device is configured to capture image of the space, and the electronic device can determine the arrangement or configuration information of the space based on the image. The audio recording device records a test audio played by the audio playing device and output a corresponding audio signal. The electronic device is further configured to determine an acoustic parameter (e.g., acoustic absorption coefficient or acoustic reflection coefficient) for each object in the space based on the audio signal and the arrangement or configuration information of the space.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates a block diagram of a system for analyzing sound field in accordance with an embodiment of the present disclosure;

FIG. 2 illustrates a schematic top view of the system shown in FIG. 1 deployed in a space;

FIG. 3 illustrates a schematic diagram of a signal processing task carried out by the electronic device shown in FIG. 1; and

FIG. 4 illustrates a schematic side view of the audio recording device and the rotation mechanism shown in FIG. 1.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

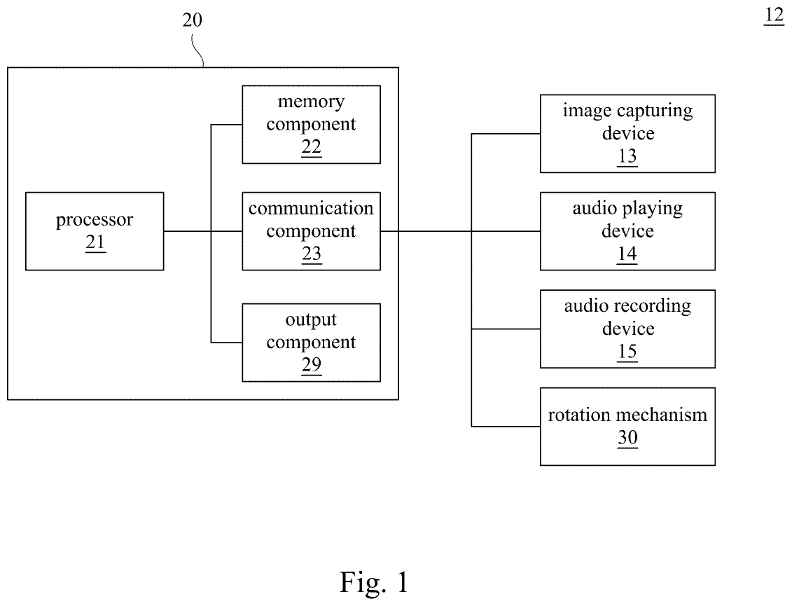

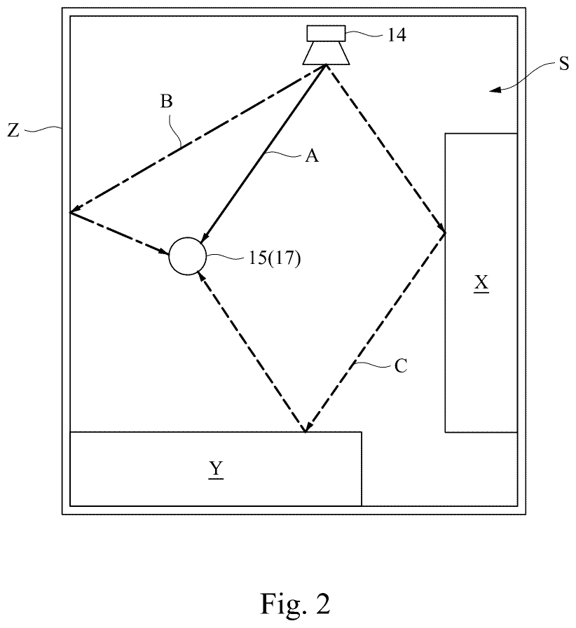

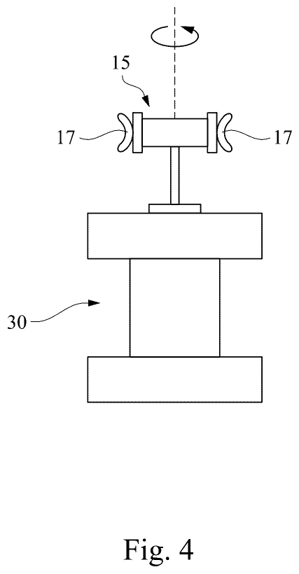

Reference is made to FIGS. 1 and 2. FIG. 1 illustrates a block diagram of a system 12 for analyzing sound field in accordance with an embodiment of the present disclosure. FIG. 2 illustrates a schematic top view of the system 12 shown in FIG. 1 deployed in a space S (e.g., an indoor place). The system 12 includes at least one image capturing device 13, an audio playing device 14 and an audio recording device 15. The image capturing device 13 is, for example, a camera or a video camera, and can be used to capture images or videos. The image capturing device 13 is disposed in the space S and is configured to capture at least one image of the space S. The audio playing device 14 is, for example, a speaker. The audio playing device 14 is disposed in the space S and is configured to play a test audio (e.g., an audio pulse). The audio recording device 15 is disposed in the space S and includes at least one audio recording unit 17 (e.g., at least one microphone; see FIG. 4). While the audio playing device 14 is playing the test audio, the audio recording unit 17 actively records the test audio and correspondingly outputs an audio signal.

As shown in FIGS. 1 and 2, the audio playing device 14 and the audio recording device 15 are disposed at different locations in the space S. For example, when the system 12 is used to analyze music listening experience, the audio playing device 14 can be placed at a location where the sound system is planned to be placed, and the audio recording device 15 can be placed at a location where the user plans to listen to music. The image capturing device 13 (omitted in FIG. 2) can be placed near the center of the space S to facilitate shooting and capturing various objects in the space S. In some embodiments, the image capturing device 13 and the audio recording device 15 can be placed at the same location.

As shown in FIGS. 1 and 2, the system 12 further includes an electronic device 20 communicably coupled to the image capturing device 13, the audio playing device 14 and the audio recording device 15. The electronic device 20 can control the operation of each component of the system 12 and can also perform data analysis. The electronic device 20 includes a processor 21, a memory component 22, a communication component 23 and an output component 29. The processor 21 is configured to perform computing tasks. The processor 21 may include at least one of the following: a central processing unit (CPU), a graphics processing unit (GPU), an application-specific integrated circuit (ASIC), a field programmable gate array (FPGA) or a digital signal processor (DSP). The memory component 22 is used to store data needed by the electronic device 20. The memory component 22 may include a volatile memory and a non-volatile memory. The volatile memory may include a dynamic random access memory (DRAM) and the non-volatile memory may include a solid state drive or a mechanical hard drive. The communication component 23 is coupled to one or more external devices, such as the image capturing device 13, the audio playing device 14 and the audio recording device 15. The electronic device 20 may receive data or instructions from the external devices through the communication component 23, and may also send data or instructions to the external devices through the communication component 23. The communication component 23 includes, for example, an Ethernet controller, a Wi-Fi module, a Bluetooth module, a 4G or 5G modem, etc. The output component 29 can be used to provide information and includes, for example, a display, a speaker, a printer, etc. In some embodiments, the electronic device 20 is a mobile device, such as a smart phone, a laptop, or a tablet computer. In other embodiments, the electronic device 20 can also be a server.

The system 12 can perform a task of analyzing the sound field in the space S, which mainly includes the following three subtasks: (I) using the image capturing device 13 to capture at least one image of the space S; (II) using the audio playing device 14 to play the test audio in the space S, and while the audio playing device 14 is playing the test audio, using the audio recording unit 17 of the audio recording device 15 to record the test audio and output the audio signal corresponding to the recorded test audio; and (III) the electronic device 20 receiving the image from the image capturing device 13 and receiving the audio signal from the audio recording device 15, and then performing analysis on the received image and audio signal. The order of subtasks (I) and (II) is arbitrary. Subtask (I) can be completed before subtask (II), or subtask (II) can be completed before subtask (I), or subtasks (I) and (II) can be carried out at the same time. Subtask (III), on the other hand, must be carried out after subtasks (I) and (II).

Regarding subtask (I), in some embodiments, the electronic device 20 is configured to send a capture command to the image capturing device 13. The image capturing device 13 is configured to receive the capture command and perform an image capturing task in accordance with the capture command (i.e., capture at least one image of the space S). After the image capturing task is completed, the at least one image can be sent back to the electronic device 20. In some embodiments, the image capturing device 13 is configured to capture multiple images of the space S. In some embodiments, the image capturing device 13 is configured to capture a video of the space S, and the video is formed of multiple images of the space S.

Regarding subtask (I), in some embodiments, the system 12 can include multiple image capturing device 13 facing different directions and capturing images in different directions. In some embodiments, the system 12 can further include a rotation mechanism 30 connected to the image capturing device 13. The rotation mechanism 30 can rotate the image capturing device 13 and cause the image capturing device 13 to face multiple different directions and capture images in different directions. In some embodiments, the electronic device 20 is communicably coupled to the rotation mechanism 30 and is configured to send a rotation command to the rotation mechanism 30. The rotation mechanism 30 is configured to receive the rotation command and rotate in accordance with the rotation command. For example, the rotation command may include parameters such as the time to start rotation, the time to stop rotation, rotation speed, rotation range, and etc.

Regarding subtask (II), in some embodiments, the electronic device 20 is configured to send a play command to the audio playing device 14. The audio playing device 14 is configured to receive the play command and perform an audio playing task in accordance with the play command (i.e., play the test audio). In some embodiments, the electronic device 20 is configured to send a record command to the audio recording device 15. The audio recording device 15 is configured to receive the record command and perform an audio recording task in accordance with the record command (i.e., record the test audio and correspondingly output the audio signal). The audio signal output by the audio recording device 15 is received by the electronic device 20. In some embodiments, a volume calibration operation may be performed before performing subtask (II), so as to make the signal-to-noise ratio (SNR) meet a certain criterion (e.g., 30 dB). During calibration, the audio playing device 14 can play white noise and the audio recording device 15 can record sound for calibration. However, the present disclosure is not limited thereto.

In subtask (III), the analysis performed by the electronic device 20 mainly includes three steps: (H1) determining space information based on the at least one image of the space S, the space information including information about one or more objects in the space S; (H2) determining a plurality of sound transmission paths from the audio playing device 14 to the audio recording unit 17 based on the space information; and (H3) determining an acoustic parameter for each object in the space S based on the space information, the sound transmission paths, and the audio signal received from the audio recording device 15.

In step (H1), the electronic device 20 can apply a suitable computer vision or machine learning algorithm to analyze the image of the space S, so as to identify one or more objects in the space S and determine the information about each object, such as the position, shape, and category of each object and a range occupied by each object. In the example shown in FIG. 2, there are three objects X, Y, and Z in the space S. Object Z is, for example, a wall, and objects X and Y can be curtains, cabinets, home appliances, or other objects placed in the space S.

In some embodiments, the space information includes a list of objects, and each item in the list may include an object number for one object and information about that object. In some embodiments, the space information may also include information about the audio playing device 14 (e.g., position, orientation, etc.) and information about the audio recording unit 17 (e.g., position, orientation, etc.). The information about the audio playing device 14 and the audio recording unit 17 may be determined or calculated by the electronic device 20 based on the image of the space S, or may be manually input by a staff member.

In some embodiments, the category of each object is determined based on the image of the space S. Specifically, the electronic device 20 is configured to determine the category of each object based on the appearance (e.g., color or other visual features) of each object shown in the image of the space S. The category of each object may correspond to a material of each object. For example, the electronic device 20 can apply a suitable computer vision or machine learning algorithm to analyze the image of the space S and classify the objects in the space S, so that objects made of the same material have the same category (or have the same category with a high probability), and objects made of different materials have different categories (or have different categories with a high probability). In some embodiments, when a physical object in the space S includes multiple parts made of different materials, the electronic device 20 may identify it as multiple objects of different categories. For example, when the physical object is a wooden cabinet with a glass door, the electronic device 20 may identify it as an object of a first category plus another object of a second category.

In step (H2), the electronic device 20 can compute a plurality of sound transmission paths from the audio playing device 14 to the audio recording unit 17 based on information such as the position and orientation of the audio playing device 14, the position and orientation of the audio recording unit 17, and the position, shape, and range of each object in the space S. In addition, the electronic device 20 can also calculate the object(s) each sound transmission path passes (for example, the object(s) by which sound wave is reflected when the sound wave travels along the sound transmission path) and the angle of incidence of each sound transmission path at the object(s) it passes.

In the example shown in FIG. 2, the electronic device 20 computes three sound transmission paths from the audio playing device 14 to the audio recording unit 17: Path A, B, and C. Path A is a direct path that does not pass any object in the space S. Path B passes object Z (for example, Path B is reflected on the surface of object Z). Path C passes objects X and Y (for example, Path C is reflected on the surfaces of objects X and Y). Paths B and C are reflection paths. It should be noted that the example shown in FIG. 2 is a simplified example. In real applications, the number of reflection paths can be more than two.

In some embodiments, step (H2) can be performed by computer simulation, simulating the emission of sound waves from the audio playing device 14 in multiple directions, and determining its transmission path based on the law of reflection, and then determining multiple transmission paths from the audio playing device 14 to the audio recording unit 17 based on one or more criteria (for example, paths with too many reflections or paths that are too long may be excluded).

Regarding step (H3), in some embodiments, the electronic device 20 can preassign at least one acoustic parameter to each object in the space S based on the category of the object. The acoustic parameter may include at least one of an acoustic absorption coefficient or an acoustic reflection coefficient. Objects of the same category are preassigned the same acoustic parameter, while objects of different categories are preassigned different acoustic parameters. The preassigned acoustic parameter is a variable whose value is determined in the subsequent computation process.

Regarding step (H3), in some embodiments, the audio signal output by the audio recording unit 17 is indicative of a total energy of sound wave received by the audio recording unit 17. For example, at any time point, the amplitude of the audio signal is indicative of the total energy of sound wave received by the audio recording unit 17 at that time point. In some embodiments, the electronic device 20 is configured to determine a received sound energy for each of the sound transmission paths based on the audio signal, the space information and the sound transmission path. In addition, the electronic device 20 is configured to determine the acoustic parameter for each object in the space S based on a relation that a sum of the received sound energy associated with each of the sound transmission paths is equal to the total energy.

In some embodiments, the relation mentioned above can be expressed as P_{rec,t}=Σₙ P_{n,t}·P_{rec,t} is the total energy of sound wave received by the audio recording unit 17 at time t (or in a time interval around time t, e.g., a time interval from t−0.5 s to t+0.5 s). P_{rec,t} can be derived from the audio signal output by the audio recording unit 17. P_{n,t} is the received sound energy associated with the n^{th} sound transmission path (i.e., the energy of the sound wave travelling along the n^{th} sound transmission path received by the audio recording unit 17) at time t (or in a time interval around time t, e.g., a time interval from t−0.5 s to t+0.5 s). P_{n,t} depends on the acoustic parameter(s) of the object(s) the n^{th} sound transmission path passes (if any). If there are m objects in the space S, and their acoustic parameters are α₁, . . . , αₘ, respectively, then P_{n,t}=f(α₁, . . . , αₘ). In other words, P_{n,t} is a function of acoustic parameters α₁, . . . , αₘ. Function f is, for example, a linear function.

In some embodiments, the orientation or position of the audio recording unit 17 can change with time. In some embodiments, the audio recording unit 17 can be connected to the rotation mechanism 30 mentioned above. The rotation mechanism 30 is configured to rotate the audio recording device 15 and cause the audio recording unit 17 to record the test audio while facing different directions. At different time points, the electronic device 20 can determine different sound transmission paths from the audio playing device 14 to the audio recording unit 17 (because the position/orientation of the audio recording unit 17 is changed as the audio recording device 15 is rotated). Utilizing the relation P_{rec,t}=Σₙ P_{n,t} to perform analysis on multiple different time points, a system of linear equations having variables α₁, . . . , αₘ can be obtained. The acoustic parameters α₁, . . . , αₘ can thus be determined by solving the system of linear equations.

In some embodiments, the audio recording device 15 includes a plurality of audio recording units 17. The audio recording units 17 face different directions (i.e., have different orientations) or are placed at different locations. For each audio recording unit 17, the electronic device 20 can determine different sound transmission paths from audio playing device 14 to the audio recording unit 17. Utilizing the relation P_{rec,t}=Σₙ P_{n,t} to perform analysis on the audio signals output by multiple different audio recording units 17, a system of linear equations having variables α₁, . . . , αₘ can be obtained. The acoustic parameters α₁, . . . , αₘ can thus be determined by solving the system of linear equations.

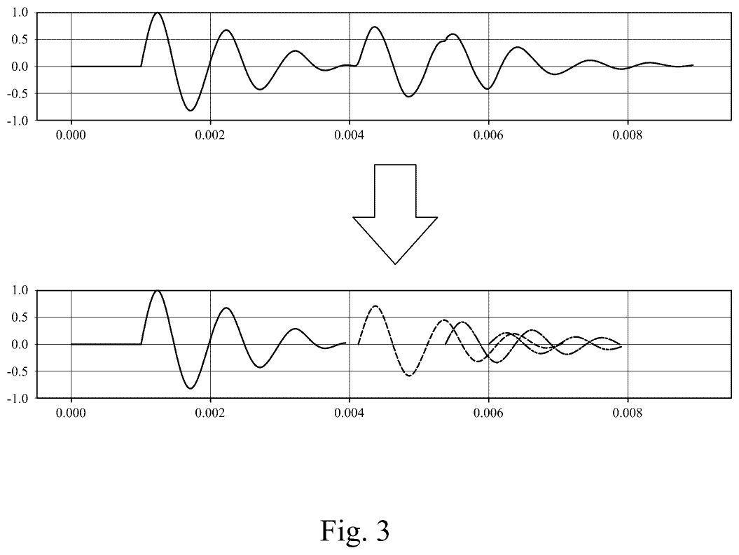

Reference is made additionally to FIG. 3. In FIG. 3, the horizontal axis represents time, and the vertical axis represents amplitude. The upper half of FIG. 3 shows the audio signal output by the audio recording unit 17. In some embodiments, the electronic device 20 is further configured to extract the received sound energy associated with the direct path from the audio signal based on a length difference between the direct path and the reflection path. The sound wave transmitted to the audio recording unit 17 via the reflection path will be delayed in time and have energy loss compared to the sound wave transmitted to the audio recording unit 17 via the direct path. Both the delay and the energy loss are related to the length of the reflection path. Therefore, with the information of the length difference between the direct path and the reflection path and applying suitable signal processing technique, the audio signal can be decomposed, as shown in the lower half of FIG. 3. Specifically, the audio signal is decomposed into a direct sound component represented by a solid line and one or more reflected sound components represented by one or more dotted lines. The received sound energy associated with the direct path can be determined based on the direct sound component.

In some embodiments, the received sound energy P_{n,t} associated with the n^{th} sound transmission path can be expressed as the received sound energy P_{dir,t} associated with the direct path multiplied by an attenuation coefficient E_{n,t}. Hence, the aforementioned relation can be rewritten as (P_{rec}/P_{dir})ₜ=Σₙ E_{n,t}.

In some embodiments, the received sound energy associated with any one of the sound transmission paths is determined at least partially based on a length of that sound transmission path. In some embodiments, the energy of sound wave is inversely proportional to the square root of the distance travelled. Hence, the attenuation coefficient E_{n,t} is proportional to sqrt(r_{dir}/rₙ), in which r_{dir} is the length of the direct path and rₙ is the length of the n^{th} sound transmission path.

In some embodiments, the received sound energy associated with any one of the reflection paths is determined at least partially based on one or more objects the reflection path passes and an angle of incidence of the reflection path at each object it passes. In some embodiments, the attenuation coefficient E_{n,t} of the n^{th} sound transmission path is proportional to πₖγₖ(θₙₖ). γₖ is the energy loss caused by the k^{th} object to the sound wave travelling along the n^{th} sound transmission path. θₙₖ is the angle of incidence of the n^{th} sound transmission path at the k^{th} object. γₖ is a function of θₙₖ. In an example wherein α is the normal acoustic absorption coefficient, γₖ(θₙₖ)=cos²θₙₖ*(1−αₖ)+sin²θₙₖ.

In some embodiments, the audio recording unit 17 has directionality. In some embodiments, the received sound energy associated with any one of the sound transmission paths is determined at least partially based on a gain of the audio recording unit 17 and an angle of incidence of that sound transmission path at the audio recording unit 17 (in other words, an audio reception angle of the audio recording unit 17). The gain is a function of the angle of incidence. In a direction where the audio recording unit 17 picks up sound well, the gain has larger value. Conversely, in a direction where the audio recording unit 17 picks up sound poorly, the gain has smaller value. In some embodiments, the attenuation coefficient E_{n,t} of the n^{th} sound transmission path is proportional to βₙ(Φₙ), in which βₙ is the gain for the n^{th} sound transmission path, and Φₙ is the angle of incidence of the n^{th} sound transmission path at the audio recording unit 17.

In some embodiments, the electronic device 20 is configured to determine the normal acoustic absorption coefficient of each object using the following equation: (P_{rec}/P_{dir})ₜ=Σₙ [sqrt(r_{dir}/rₙ)*βₙ(Φₙ)*πₖγₖ(θₙₖ)]. In some embodiments, the normal acoustic reflection coefficient can be calculated with similar equation. The normal acoustic reflection coefficient can be defined as one minus the normal acoustic absorption coefficient (when the normal acoustic absorption coefficient accounts for sound wave that transmits through the object).

In some embodiments, the electronic device 20 is further configured to determine acoustic parameters such as definition, clarity, and reverberation time of the sound field based on information such as the audio signal provided by the audio recording unit 17 and the acoustic parameters of each object determined in step (H3). In some embodiments, the electronic device 20 is further configured to determine a space arrangement suggestion information based on the acoustic parameters such as definition, clarity, and reverberation time. The space arrangement suggestion information includes, for example, suggestions for changing the position, orientation, or material of each object (for example, changing to a material with a larger or smaller acoustic absorption coefficient) to improve the listening experience. The space arrangement suggestion information can be output by the output component 29 of the electronic device 20. For example, the space arrangement suggestion information can be shown on a display.

Reference is made to FIG. 4. FIG. 4 illustrates a schematic side view of the audio recording device 15 and the rotation mechanism 30 shown in FIG. 1. In some embodiments, the audio recording device 15 is a binaural microphone, which includes two audio recording units 17 (e.g., two microphones, each paired with a human-shaped ear) to simulate the sound pickup pattern of human ears. In some embodiments, the audio recording device 15 can be placed on the rotation mechanism 30, and the rotation mechanism 30 can rotate the audio recording device 15. In some embodiments, when the rotation mechanism 30 rotates the audio recording unit 17 to a position, it stays still for a period of time to allow the audio recording unit 17 to record sound statically, and then rotates the audio recording unit 17 to the next position. The rotation interval of the audio recording unit 17 is required to be less than a specific angle (for example, fifteen degrees) to meet the test requirements.

In accordance with an embodiment of the present disclosure, a method for analyzing sound field in a space includes: (1) using an audio playing device (e.g., the audio playing device 14 mentioned above) to play a test audio in a space; (2) using at least one audio recording unit (e.g., the audio recording unit 17 mentioned above) of an audio recording device (e.g., the audio recording device 15 mentioned above) to record the test audio and correspondingly output an audio signal; (3) determining space information based on at least one image of the space, the space information including information about one or more objects in the space; (4) determining a plurality of sound transmission paths from the audio playing device to the audio recording unit based on the space information; and (5) determining an acoustic parameter for each object based on the audio signal, the space information and the sound transmission paths. In some embodiments, the method can include the various operations performed by the image capturing device 13, the audio playing device 14, the audio recording device 15 and the electronic device 20 described above.

In sum, the present disclosure provides a simple and portable sound field analysis system, which can help the user quickly perform space analysis to identify the characteristics of an environment or a space. The system includes an image capturing device, an audio playing device, an audio recording device and an electronic device. The image capturing device is configured to capture image of the space, and the electronic device can determine the arrangement or configuration information of the space based on the image. The audio recording device records a test audio played by the audio playing device and output a corresponding audio signal. The electronic device is further configured to determine an acoustic parameter (e.g., acoustic absorption coefficient or acoustic reflection coefficient) for each object in the space based on the audio signal and the arrangement or configuration information of the space.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. A system for analyzing sound field in a space, comprising:
an image capturing device configured to capture at least one image of the space;
an audio playing device disposed in the space and configured to play a test audio;
an audio recording device disposed in the space and comprising at least one audio recording unit, the at least one audio recording unit being configured to record the test audio and correspondingly output an audio signal; and
an electronic device communicably coupled to the image capturing device and the audio recording device and configured to:
receive the at least one image and the audio signal;
determine space information based on the at least one image, wherein the space information comprises information about one or more objects in the space;
determine a plurality of sound transmission paths from the audio playing device to the at least one audio recording unit based on the space information; and
determine an acoustic parameter for each of the one or more objects based on the audio signal, the space information and the sound transmission paths.

2. The system of claim 1, wherein the audio signal is indicative of a total energy of sound wave received by the at least one audio recording unit, and the electronic device is further configured to:
determine a received sound energy for each of the sound transmission paths based on the audio signal, the space information and the sound transmission paths; and
determine the acoustic parameter for each of the one or more objects based on a relation that a sum of the received sound energy associated with each of the sound transmission paths is equal to the total energy.

3. The system of claim 2, wherein the sound transmission paths comprise a reflection path, the electronic device is configured to determine the received sound energy associated with the reflection path at least partially based on one or more first objects the reflection path passes and an angle of incidence of the reflection path at each of the one or more first objects, wherein the one or more first objects are included in the one or more objects.

4. The system of claim 3, wherein the sound transmission paths further comprise a direct path, the electronic device is further configured to extract the received sound energy associated with the direct path from the audio signal based on a length difference between the direct path and the reflection path, wherein the received sound energy associated with the reflection path is expressed as the received sound energy associated with the direct path multiplied by an attenuation coefficient.

5. The system of claim 2, wherein the electronic device is configured to determine the received sound energy associated with any one of the sound transmission paths at least partially based on a length of that sound transmission path.

6. The system of claim 2, wherein the electronic device is configured to determine the received sound energy associated with any one of the sound transmission paths at least partially based on a gain of the at least one audio recording unit and an angle of incidence of that sound transmission path at the at least one audio recording unit, wherein the gain is a function of the angle of incidence.

7. The system of claim 6, wherein the audio recording device comprises a binaural microphone.

8. The system of claim 1, wherein the space information comprises a category of each of the one or more objects, and the category is determined based on the at least one image.

9. The system of claim 1, wherein the acoustic parameter comprises at least one of an acoustic absorption coefficient or an acoustic reflection coefficient.

10. The system of claim 1, further comprising a rotation mechanism connected to the audio recording device, wherein the rotation mechanism is configured to rotate the audio recording device and cause the at least one audio recording unit to record the test audio while facing different directions.

11. A method for analyzing sound field in a space, comprising:
using an audio playing device to play a test audio in a space;
using at least one audio recording unit of an audio recording device to record the test audio and correspondingly output an audio signal;
determining space information based on at least one image of the space, the space information comprising information about one or more objects in the space;
determining a plurality of sound transmission paths from the audio playing device to the at least one audio recording unit based on the space information; and
determining an acoustic parameter for each of the one or more objects based on the audio signal, the space information and the sound transmission paths.

12. The method of claim 11, wherein the audio signal is indicative of a total energy of sound wave received by the at least one audio recording unit, and the method further comprises:
determining a received sound energy for each of the sound transmission paths based on the audio signal, the space information and the sound transmission paths; and
determining the acoustic parameter for each of the one or more objects based on a relation that a sum of the received sound energy associated with each of the sound transmission paths is equal to the total energy.

13. The method of claim 12, wherein the determining the received sound energy comprises determining the received sound energy associated with a reflection path of the sound transmission paths at least partially based on one or more first objects the reflection path passes and an angle of incidence of the reflection path at each of the one or more first objects, wherein the one or more first objects are included in the one or more objects.

14. The method of claim 13, wherein the determining the received sound energy comprises extracting the received sound energy associated with a direct path of the sound transmission paths from the audio signal based on a length difference between the direct path and the reflection path, wherein the received sound energy associated with the reflection path is expressed as the received sound energy associated with the direct path multiplied by an attenuation coefficient.

15. The method of claim 12, wherein the received sound energy associated with any one of the sound transmission paths is determined at least partially based on a length of that sound transmission path.

16. The method of claim 12, wherein the received sound energy associated with any one of the sound transmission paths is determined at least partially based on a gain of the at least one audio recording unit and an angle of incidence of that sound transmission path at the at least one audio recording unit, wherein the gain is a function of the angle of incidence.

17. The method of claim 16, wherein the audio recording device comprises a binaural microphone.

18. The method of claim 11, wherein the determining the space information comprises: determining a category of each of the one or more objects based on the at least one image.

19. The method of claim 11, wherein the acoustic parameter comprises at least one of an acoustic absorption coefficient or an acoustic reflection coefficient.

20. The method of claim 11, further comprising: rotating the audio recording device and causing the at least one audio recording unit to record the test audio while facing different directions.
